(19) United States
(12) Patent Application Publication
(10) Pub. No.: US 2018/0061405 A1
(43) Pub. Date: Mar. 1, 2018

(54) Voice guide device and a method thereof

(71) Applicant: WALTON ADVANCED ENGINEERING INC., Kaohsiung (TW)

(72) Inventors: Hong Chi YU, Kaohsiung (TW); Mao Ting CHANG, Kaohsiung (TW); Yu Tsung LAN, Kaohsiung (TW); Chun Neng HUANG, Kaohsiung (TW); Chao Yao CHEN, Kaohsiung (TW)

(73) Assignee: WALTON ADVANCED ENGINEERING INC., Kaohsiung (TW)

(21) Appl. No.: 15/364,481

(22) Filed: Nov. 30, 2016

(30) Foreign Application Priority Data
Aug. 26, 2016 (TW) 105127437

(51) Int. Cl. G10L 15/22; G06F 3/16

(52) U.S. Cl. CPC G10L 15/22; G06F 3/167

(57) ABSTRACT

A voice guide device and a method thereof provided in the present disclosure are characterized that a terminal module is inserted into a smart device's jack through which a little electricity is received, stored, transformed and transmitted to a voice generation unit so that an audio signal, which is generated with default voice data read, is transmitted to the smart device from a terminal module for driving the smart device.

### BACKGROUND OF THE INVENTION

1) Field of the Invention

The present disclosure relates to a device based on a smart device's voice instructions to activate a specific function and a method thereof, particularly a device which relies on a smart device's built-in headphone jack as a power source and features a distinct input procedure differing from conventional techniques.

2) Description of the Prior Art

Based on the philosophy of technologies always coming from human natures, the various desired functions have been brought into our lives in virtue of popularization of smart phones in which main operation systems for mobile devices such as Android and IOS created by Apple are installed.

To operate a smart phone, a touch panel interface broke the mold of human-machine interactions which relied on physical buttons originally. Furthermore, people have been expecting to interactions with machines by natural languages and embody the interactions in operation systems since the birth of the Internet of Things (IoT) and various smart phones.

As the most common tools to embody interactions with machines by natural languages, Google Now and Siri (Speech Interpretation and Recognition Interface) are familiar to users who complete interactions with mobile phones through natural conversations to search information, check weather summary, set and query a calendar on a mobile phone, set a snooze alarm, and so on.

Currently, existing applications such as querying website, checking weather summary, setting and querying calendars, and setting snooze alarms are providing more fast marketing and commercial channels to users.

### SUMMARY OF THE INVENTION

To promote applications, a voice guide device and a method thereof provided in the present disclosure rely on a smart device's built-in headphone jack as an input source, which is connected to a voice guide device for supplying electric power and opening a specific website according to a feedback voice instruction received by the smart device.

A voice guide device and a method thereof provided in the present disclosure rely on a universal headphone jack common in a mobile device in which a specific operation system is installed to quickly and effectively access a specific website.

A voice guide device and a method thereof provided in the present disclosure send a voice instruction not heard by outsiders for privacy and safety.

A voice guide device and a method thereof provided in the present disclosure allow an online shop to promote effective internet marketing and a user, who needs not to remember any specific URL, to access and browse a specific website for follow-up internet behaviors.

To this end, a voice guide device and a method thereof are embodied with major technical measures as follows.

A voice guide device in the present embodiment comprises a terminal module and an audio output module: the terminal module comprises two audio input units, an audio output unit, a ground unit, and three insulation units among the audio input units, the audio output unit and the ground unit; the audio output module comprises a storage unit, a voice generation unit and a power storage component, all of which are mounted on a substrate; the storage unit stores voice data and the power storage component comprises a capacitor unit and a transformer unit. A voice guide device is characterized that the terminal module is inserted into a smart device's jack from which the audio input units and the audio output unit are electrically connected to the smart device, the power storage component stores electricity supplied by the audio input units in the capacitor unit from which electricity is transmitted to all components on the substrate from the transformer unit, and the voice generation unit reading the voice data creates an audio signal which is transmitted to the smart device through the audio output unit.

A voice guide device and a method thereof further rely on following technical measures to realize purposes and techniques.

In the voice guide device, the terminal module comprises the audio input unit, the insulation unit, the audio input unit, the insulation unit, the audio output unit, the insulation unit and the ground unit from top to down.

In the voice guide device, the terminal module comprises the audio input unit, the insulation unit, the audio input unit, the insulation unit, the ground unit, the insulation unit and the audio output unit from top to down.

In the voice guide device, the audio output module comprises a switch mounted on the substrate.

In the voice guide device, the audio output module comprises a housing.

To this end, the present disclosure provides following main technical measures to realize purposes and techniques. A method of a voice guide device comprises steps as follows: step 1: a terminal module on a voice guide device is inserted into a jack on a smart device; step 2: two audio input units and an audio output unit of the terminal module are electrically connected to the smart device; step 3: electrical energy is stored in a capacitor unit of a power storage component in the voice guide device through the audio input units and transmitted to electronic components on a substrate of the voice guide device from a transformer unit of the power storage component; step 4: an audio signal is created by a voice generation unit of the electrically activated audio output module when voice data from a storage unit of the audio output module is read by the voice generation unit; step 5: the audio signal is transmitted to the smart device from the audio output unit; step 6: a specific website referring to the audio signal is opened on a browser of the smart device when the audio signal is received by a voice assistant in the smart device.

The present disclosure further provides following steps to realize purposes and techniques.

In addition to the above steps, electricity is supplied to the audio output module from the power storage component with a switch on the audio output module pressed after step 3.

In contrast to conventional techniques, a voice guide device and a method thereof in the present disclosure are characterized that: (1) a browse program is automatically enabled and a specific URL is entered without requirement of manual input; (2) a user, who needs not to remember any specific URL, accesses and browses a specific website for follow-up internet behaviors and an online shop promotes effective internet marketing; (3) a universal headphone jack is available without the compatibility issue.

### BRIEF DESCRIPTIONS OF THE DRAWINGS

FIG. 1a is a first sectional view of a terminal module in a preferred embodiment;

FIG. 1b is a second sectional view of a terminal module in a preferred embodiment;

FIG. 2 is a block diagram for a voice guide device in a preferred embodiment;

FIG. 3 is a first flow chart to operate a method of a voice guide device in a preferred embodiment; and

FIG. 4 is a second flow chart to operate a method of a voice guide device in a preferred embodiment.

### DETAILED DESCRIPTIONS OF THE PREFERRED EMBODIMENTS

A voice guide device and a method thereof will be further illustrated in preferred embodiments for clear understanding of purposes, characteristics and effects:

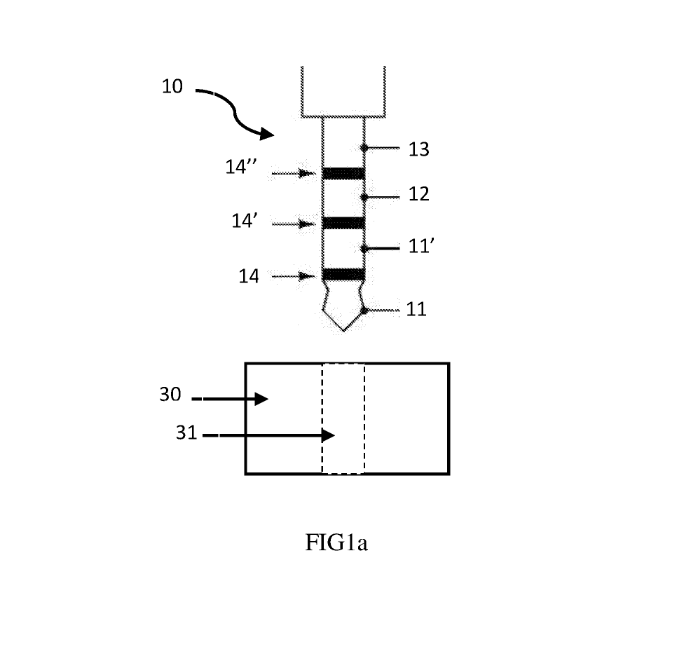

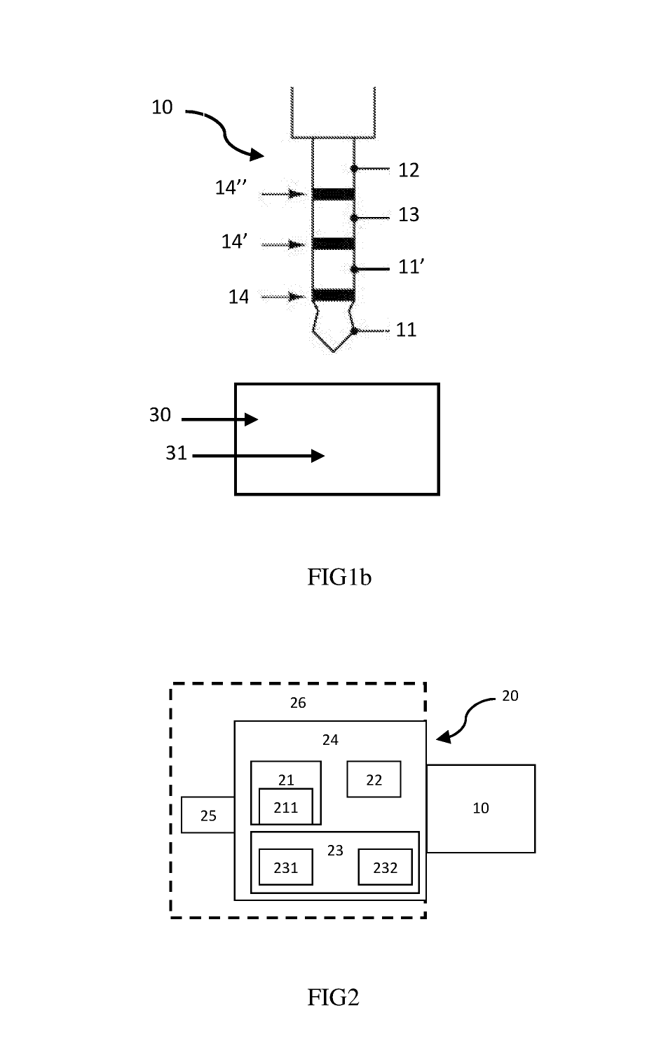

Referring to FIGS. 1a to 4, which illustrate a voice guide device and a method thereof in embodiments. As shown in FIG. 2, a voice guide device in the present disclosure comprises a terminal module (10) and an audio output module (20).

In the voice guide device, the terminal module (10) comprises two audio input units (11, 11′), an audio output unit (12), a ground unit (13) and three insulation units (14, 14′, 14″) among the audio input units (11, 11′), the audio output unit (12) and the ground unit (13), as shown in FIG. 1a or 1b.

In the voice guide device, the audio output module (20) comprises a storage unit (21), a voice generation unit (22) and a power storage component (23), all of which are mounted on a substrate (24), as shown in FIG. 2; the storage unit (21) stores voice data (211) and the power storage component (23) comprises a capacitor unit (231) and a transformer unit (232).

Specifically, the audio input units (11, 11′) are interfaces receiving signals of right and left audio channels, respectively; the audio output unit (12) is an interface sending microphone signals, the ground unit (13) is an electric potential reference of internal circuits for measurements of other electric potentials; the insulation units (14, 14′, 14″) are made of separated non-conducting materials. The terminal module (10) can be divided into two types, for example, the audio input unit (11), the insulation unit (14), the audio input unit (11′), the insulation unit (14′), the audio output unit (12), the insulation unit (14″) and the ground unit (13) from top to down, as shown in FIG. 1a, or the audio input unit (11), the insulation unit (14), the audio input unit (11′), the insulation unit (14′), the ground unit (13), the insulation unit (14″) and the audio output unit (12) from top to down, as shown in FIG. 1b. The two types of terminal module (10) are attributed to two interface definition standards for 3.5 mm 4-pole (TRRS) plugs on smart devices, OMTP (Open Mobile Terminal Platform) and CTIA (Cellular Telephone Industries Association), each of which has same definitions for a plug's first two segments, that is, positive polarity of left and right audio channels from top to down, but different definitions for a plug's second two segments, that is, positive polarity of MIC as well as ground from top to down (OMTP) and ground as well as positive polarity of MIC from top to down (CTIA).

Furthermore, the storage unit (21) means nonvolatile memories saving data which is inerasable with power disconnected but readable with power resumed; the voice generation unit (22) means a processor, for example, micro processor (μP) which is a specific programmable IC; the capacitor unit (231) means a capacitor, a circuit component with insulating medium held in two metal sheets for field-induced energy stored between two conducts with equal charges; the transformer unit (232) based on the Faraday's law of induction is a device to raise or reduce voltages and usually comprises two or more coils by which AC voltages are regulated, resistance is changed and circuits are separated; the substrate (24) is a printed circuit board which is an important electronic subassembly to support and connect electronic components.

Preferably, the audio output module (20) comprises a switch (25) and a housing (26): the switch (25) is mounted on the substrate (24); the switch (25) controls the power storage component (23) to supply electricity to other electronic components; the housing (26) shields components in the audio output module (20).

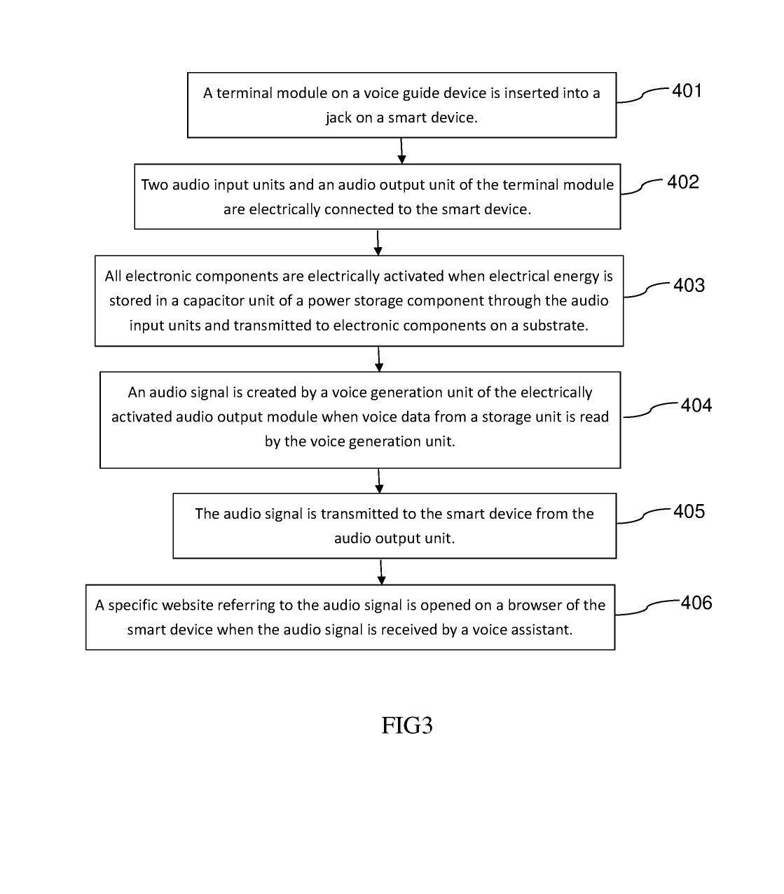

Referring to FIG. 3, which is a flowchart for operation of a voice guide device and illustrates steps as follows: step 1 (401): a terminal module (10) on a voice guide device is inserted into a jack (31) on a smart device (30) for physical contact, as shown in FIGS. 1a and 3; step 2 (402): two audio input units (11, 11′) and an audio output unit (12) of the terminal module (10) in the voice guide device are electrically connected to the smart device (30); step 3 (403): all electronic components are electrically activated when electrical energy is stored in a capacitor unit (231) of a power storage component (23) in the voice guide device through the audio input units (11, 11′) and transmitted to electronic components on a substrate (24) of the voice guide device from a transformer unit (232) of the power storage component (23); step 4 (404): an audio signal (221) is created by a voice generation unit (22) of the electrically activated audio output module (20) when voice data (211) from a storage unit (21) of the audio output module (20) is read by the voice generation unit (22); step 5 (405): the audio signal (221) is transmitted to the smart device (30) from the audio output unit (12); step 6 (406): a specific website referring to the audio signal (221) is opened on a browser of the smart device (30) when the audio signal (221) is received by a voice assistant in the smart device (30).

In these steps, the terminal module (10) in step 1 (401) and step 2 (402) is a 4-pole (TRRS) plug specifically so that an audio signal is transmitted to the smart device (30) from the audio output unit (12) in step 4 (404) and step 5 (405) with a little electrical power from the smart device (30) supplied to the audio input units (11, 11′) in step 2 (402) and step 3 (403).

After step 2 (402), a little electrical power from the smart device (30) in step 3 (403) is supplied to the audio input units (11, 11′) and stored in the capacitor unit (231) because the electrical power in a distinct device is not precisely estimated in practice. The sufficient electrical power stored in the capacitor unit (231) and matching specifications will be supplied to electronic components from the transformer unit.

In step 4 (404), the voice generation unit (22) and the storage unit (21) on the substrate (24) is activated with sufficient electrical power received in step 3 (403); then, an audio signal (221) is created by the voice generation unit (22) when voice data (211) from the storage unit (21) of the audio output module (20) is read by the voice generation unit (22). In step 4 (404), the voice data (211), which is digital data of acoustic waves or texts, is transformed to an analog audio signal (221) by the voice generation unit (22) and the analog audio signal (221) is further transmitted to the smart device (30) in step 5 (405).

In step 6 (406), a specific website referring to the analog audio signal (221) created in step 5 (405) and received by a voice assistant is opened on a browser according to default configurations of the voice assistant. In this regard, the voice data (211) comprises some critical voice instructions such as “Open” and “URL” (e.g., www.yahooo.com) requested by the voice assistant.

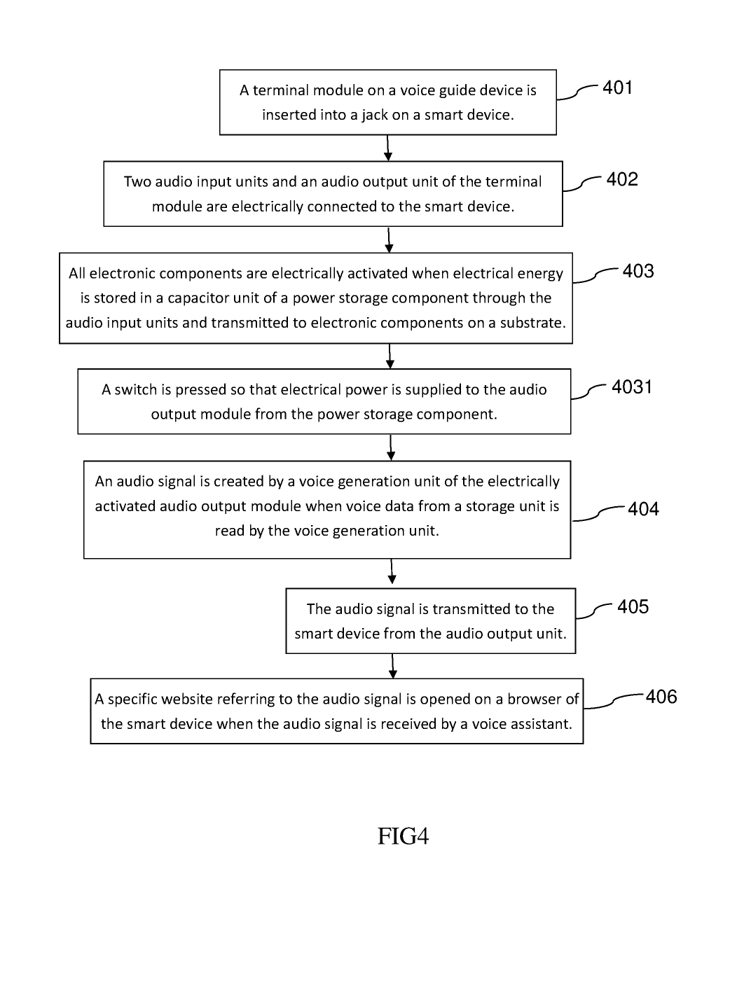

Preferably, step 3-1 (4031) is added after step 3 (403), as shown in FIG. 4. In step 3-1 (4031), a switch (25) on the audio output module (20) is pressed so that electrical power is supplied to the audio output module (20) from the power storage component (23). The additional step 3-1 (4031) allows a user to trigger a voice guide device in the present disclosure and prevent the voice guide device from self-running without permission.

A practical procedure to clearly present functions of a voice guide device is particularly shown as follows.

In step 1 (401) in FIG. 4, a terminal module (10) on a voice guide device, as shown in FIG. 1a or 1b, is inserted into a jack (31) on a smart device (30).

In step 2 (402) following step 1 (401) in FIG. 4, the smart device (30) is electrically connected to two audio input units (11, 11′) and an audio output unit (12) of the terminal module (10).

In step 3 (403) following step 2 (402) in FIG. 4, all electronic components are electrically activated when electrical energy is stored in a capacitor unit (231) of a power storage component (23) in the voice guide device through the audio input units (11, 11′) and transmitted to electronic components (FIG. 2) on a substrate (24) of the voice guide device from a transformer unit (232) of the power storage component (23).

In step 3-1 (4031) in FIG. 4, a switch (25) on the audio output module (20) is pressed so that electrical power is supplied to the audio output module (20) from the power storage component (23).

In step 4 (404) following step 3-1 (4031) in FIG. 4, an audio signal (221) is created by a voice generation unit (22) of the electrically activated audio output module (20) when voice data (211), digital data of acoustic waves or texts, from a storage unit (21) is read by the voice generation unit (22).

In step 5 (405), the audio signal (221) created in step 4 (404) is transmitted to and received by the smart device (30) via the audio output unit (12).

In step 6 (406), a specific website referring to the analog audio signal (221), which is created in step 5 (405), received by a voice assistant and recognized as initial text instructions, is opened on a browser according to default configurations of the voice assistant.

Accordingly, a voice guide device differing from conventional guide devices and referred to as creative work in applications of an audio signal terminal technique meets patentability and is applied for the patent.

It should be reiterated that the above descriptions present the preferred embodiment, and any equivalent change in specifications, claims, or drawings still belongs to the technical field within the present disclosure with reference to claims hereinafter.

What is claimed is:

1. A voice guide device, comprising a terminal module (10) and an audio output module (20):
the terminal module (10), comprising two audio input units (11, 11′), an audio output unit (12), a ground unit (13) and three insulation units (14, 14′, 14″) among the audio input units (11, 11′), the audio output unit (12) and the ground unit (13);
the audio output module (20), comprising a storage unit (21), a voice generation unit (22) and a power storage component (23), all of which are mounted on a substrate (24), wherein the storage unit (21) stores voice data (211) and the power storage component (23) comprises a capacitor unit (231) and a transformer unit (232);
a voice guide device characterized that the terminal module (10) is inserted into a jack (31) on a smart device (30) from which the audio input units (11, 11′) and the audio output unit (12) are electrically connected to the smart device (30), the power storage component (23) stores electricity supplied by the audio input units (11, 11′) in the capacitor unit (231) from which electricity is transmitted to all components on the substrate (24) by the transformer unit (232), and the voice generation unit (22) reading the voice data (211) creates an audio signal (221) which is transmitted to the smart device (30) through the audio output unit (12).

2. A voice guide device as claimed in claim 1 wherein the terminal module (10) comprises the audio input unit (11), the insulation unit (14), the audio input unit (11′), the insulation unit (14′), the audio output unit (12), the insulation unit (14″) and the ground unit (13) from top to down.

3. A voice guide device as claimed in claim 1 wherein the terminal module (10) comprises the audio input unit (11), the insulation unit (14), the audio input unit (11′), the insulation unit (14′), the ground unit (13), the insulation unit (14″) and the audio output unit (12) from top to down.

4. A voice guide device as claimed in claim 1 wherein the audio output module (20) comprises a switch (25) mounted on the substrate (24).

5. A voice guide device as claimed in claim 1 wherein the audio output module (20) comprises a housing (26).

6. A method of a voice guide device a, comprising steps as follows: step 1: a terminal module on a voice guide device is inserted into a jack on a smart device (401); step 2: two audio input units and an audio output unit of the terminal module are electrically connected to the smart device (402); step 3: electrical energy is stored in a capacitor unit of a power storage component in the voice guide device through the audio input units and transmitted to electronic components on a substrate of the voice guide device from a transformer unit of the power storage component (403); step 4: an audio signal is created by a voice generation unit of the electrically activated audio output module when voice data from a storage unit of the audio output module is read by the voice generation unit; step 5: the audio signal is transmitted to the smart device from the audio output unit (405); step 6: a specific website referring to the audio signal is opened on a browser of the smart device when the audio signal is received by a voice assistant in the smart device (406).

7. A voice guide device as claimed in claim 6 wherein electricity is supplied to the audio output module from the power storage component with a switch on the audio output module pressed after step 3 (4031).
